(19) United States
(12) Patent Application Publication
(10) Pub. No.: US 2022/0158997 A1
(43) Pub. Date: May 19, 2022

(54) End-to-End Product Authentication Technique

(71) Applicant: EVRYTHNG Ltd, London (GB)

(72) Inventors: Dominique Guinard, Yverdon-les-Bains (CH); Niall Murphy, London (GB); Shmuel Silverman, Novato, CA (US)

(73) Assignee: EVRYTHNG Ltd, London (GB)

(21) Appl. No.: 17/340,546

(22) Filed: Jun. 7, 2021

Related U.S. Application Data
(63) Continuation of application No. 17/340,503, filed on Jun. 7, 2021.
(60) Provisional application No. 63/115,183, filed on Nov. 18, 2020.

(51) Int. Cl. H04L 29/06; G06N 20/00

(52) U.S. Cl. CPC H04L 63/0876; G06N 20/00; H04L 63/0853

(57) ABSTRACT

A computer that performs product authentication is described. During operation, the computer may receive, from the electronic device, a request to authenticate authenticity of a product, where the request includes information specifying the product. Moreover, the computer may determine the authenticity of the product, where the determining includes providing a set of questions addressed to the electronic device and receiving answers to the set of questions associated with the electronic device, and at least some of the questions in the set of questions are dynamically selected based at least in part on at least some of the answers. Furthermore, the computer may provide, addressed to the electronic device, information specifying the determined authenticity.

### CROSS REFERENCE TO RELATED APPLICATIONS

This application is a continuation of U.S. patent application Ser. No. 17/340,503, “End-to-End Product Authentication Technique,” by Dominique Guinard, et al., filed on Jun. 7, 2021, which claims priority under 35 U.S.C. 119(e) to U.S. Provisional Application Ser. No. 63/115,183, entitled “Product Authentication Technique,” by Dominique Guinard, et al., filed on Nov. 18, 2020, the contents of both of which are herein incorporated by reference.

### BACKGROUND

### Field

The described embodiments relate generally to techniques for authenticating a product or a service.

### Related Art

While authentication techniques for distinguishing counterfeit products from genuine ones are available, they often vary for each type of brand and/or product. In these existing authentication approaches, an online marketplace that wants to offer verification of authenticity usually has to implement an authentication technique for each type of listed product and/or brand, which is typically impractical. Moreover, a given marketplace may need to maintain a large number of different product-authentication techniques and may need to adapt these authentication techniques to align with the evolving requirements introduced by regulators and brands. Consequently, online marketplaces often have liability for a high number of false positives or false negative authentication results.

Furthermore, many existing authentication techniques are particular or specific to third parties and, therefore, do not support uniform authentication. Notably, there usually is not a consistent authentication technique that allows prospective sellers of a product to validate the product with a principal brand owner before listing it for sale. While some specific products can be evaluated for authenticity by the originator of that product, the existing authentication approaches typically do not allow for consistent and independent authenticity evaluation of an arbitrary product by a third party.

Additionally, even when a product is authenticated, it is usually difficult to guarantee that the product purchased by a buyer is in fact the product that is delivered at the intended destination. Instead, buyers are often vulnerable to so-called ‘man in the middle’ attacks, in which a purchased product is swapped or substituted with a counterfeit product while enroute to the destination.

### SUMMARY

In a first group of embodiments, a computer that performs product authentication is described. This computer may include: an interface circuit that communicates with an electronic device (which may be remotely located from the computer); a processor; and memory that stores program instructions. During operation, the computer provides, addressed to the electronic device, information specifying a document at a location in a network, where the document is associated with an online marketplace and comprises second information associated with a product or a service. Moreover, the information may include authentication information that confirms an authenticity of the product or the service, and the authentication is specific (or unique) to the product or the service and the document.

Note that the authentication information may be based at least in part on a layout or a structure of the document. For example, when the document changes, the authentication information may be invalidated.

Moreover, the document may include a web page or a website. Furthermore, the network may include the Internet.

Additionally, the authentication information may be specific to the computer. In these embodiments, when the document changes, the authentication information may be invalidated.

In some embodiments, the authentication information may include a unique code. Alternatively or additionally, the authentication information may include a link to another location in the network with the unique code. The unique code may be based at least in part on the document, a layout of the document, or a structure of the document, and may be based at least in part on a second unique code associated with the product or the service. Note that the second unique code may be associated with a manufacturer or a provider of the product or the service. In some embodiments, the second unique code may be based at least in part on a hash function.

Another embodiment provides the electronic device.

Another embodiment provides a computer-readable storage medium for use with the computer. When executed by the computer, this computer-readable storage medium causes the computer to perform at least some of the aforementioned operations.

Another embodiment provides a method that may be performed by the computer. This method includes at least some of the aforementioned operations.

In a second group of embodiments, a computer that performs product authentication is described. This computer may include: an interface circuit that communicates with an electronic device (which may be remotely located from the computer); a processor; and memory that stores program instructions. During operation, the computer receives, from the electronic device, a request to authenticate authenticity of a product, where the request includes information specifying the product. Moreover, the computer determines the authenticity of the product, where the determining includes providing a set of questions addressed to the electronic device and receiving answers to the set of questions associated with the electronic device, and at least some of the questions in the set of questions are dynamically selected based at least in part on at least some of the answers. Furthermore, the computer provides, addressed to the electronic device, information specifying the determined authenticity.

Note that the product may have been manufactured before existence of an authentication service associated with the computer.

Moreover, the authenticity may be determined using a group of predefined authentication modules that are selected based at least in part on the product. For example, the group of predefined authentication modules may include a pre-trained machine-learning model. Alternatively or additionally, a sequence of the group of predefined authentication modules may be selected based at least in part on the product.

Furthermore, the authenticity may be determined based at least in part on a context of the authentication. For example, the context may include a document in a network that is offering the product. Note that the document may include: a location of the document; and/or a web page or a website. Alternatively or additionally, the context may include: a number of authentication attempts for the product; a location in a network of the electronic device, which is purchasing the product; and/or an authentication history of a purchaser of the product.

In some embodiments, the set of questions may include a request for information associated with a label of the product. For example, the information may include an image of the label. Note that the determining may include analyzing the label to identify random markings at different locations in the label.

Moreover, the determining may include requesting information from a counterparty to a party associated with the electronic device in a transaction associated with the product.

Furthermore, the computer may provide instances of a common user interface to the party and the counterparty during the determining.

Additionally, the determining may include requesting information from a manufacturer of the product.

Another embodiment provides the electronic device.

Another embodiment provides a computer-readable storage medium for use with the computer. When executed by the computer, this computer-readable storage medium causes the computer to perform at least some of the aforementioned operations.

Another embodiment provides a method that may be performed by the computer. This method includes at least some of the aforementioned operations.

In a third group of embodiments, a computer that performs product authentication is described. This computer may include: an interface circuit that communicates with an electronic device (which may be remotely located from the computer); a processor; and memory that stores program instructions. During operation, the computer may provide, addressed to the electronic device, authentication information for a product, where the authentication information confirms authenticity of the product throughout a fulfillment chain of the product.

Note that the fulfillment chain may include display of the product in a document at a location in a network. For example, the document may include a web page or a website. Alternatively or additionally, the authentication information may confirm the authenticity of a displayed instance of the product. Moreover, the authenticity may be invalid when a displayed instance of the product is different from a delivered instance of the product.

Furthermore, the fulfillment chain may include delivery of the product at a destination address of a purchaser.

Additionally, the authentication information may confirm that the product is unchanged throughout the fulfillment process.

In some embodiments, the fulfillment chain may include one or more instances of packaging the product.

Another embodiment provides the electronic device.

Another embodiment provides a computer-readable storage medium for use with the computer. When executed by the computer, this computer-readable storage medium causes the computer to perform at least some of the aforementioned operations.

Another embodiment provides a method that may be performed by the computer. This method includes at least some of the aforementioned operations.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating an example of communication among electronic devices in accordance with an embodiment of the present disclosure.

FIG. 2 is a flow diagram illustrating an example of a method for authenticating a product or a service using a computer of FIG. 1 in accordance with an embodiment of the present disclosure.

FIG. 3 is a drawing illustrating an example of communication among electronic devices in FIG. 1 in accordance with an embodiment of the present disclosure.

FIG. 4 is a flow diagram illustrating an example of a method for authenticating a product or a service using a computer of FIG. 1 in accordance with an embodiment of the present disclosure.

FIG. 5 is a drawing illustrating an example of communication among electronic devices in FIG. 1 in accordance with an embodiment of the present disclosure.

FIG. 6 is a flow diagram illustrating an example of a method for authenticating a product or a service using a computer of FIG. 1 in accordance with an embodiment of the present disclosure.

FIG. 7 is a drawing illustrating an example of communication among electronic devices in FIG. 1 in accordance with an embodiment of the present disclosure.

FIG. 8 is a drawing illustrating an example of communication among electronic devices in FIG. 1 in accordance with an embodiment of the present disclosure.

FIG. 9 is a drawing illustrating an example of communication among electronic devices in FIG. 1 in accordance with an embodiment of the present disclosure.

FIG. 10 is a drawing illustrating an example of communication among electronic devices in FIG. 1 in accordance with an embodiment of the present disclosure.

FIG. 11 is a drawing illustrating an example of communication among electronic devices in FIG. 1 in accordance with an embodiment of the present disclosure.

FIG. 12 is a flow diagram illustrating an example of a method for authenticating a product or a service using a computer of FIG. 1 in accordance with an embodiment of the present disclosure.

FIG. 13 is a drawing illustrating an example of communication among electronic devices in FIG. 1 in accordance with an embodiment of the present disclosure.

FIG. 14 is a flow diagram illustrating an example of a method for authenticating a product or a service using a computer of FIG. 1 in accordance with an embodiment of the present disclosure.

FIG. 15 is a block diagram illustrating an example of an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

A system and authentication technique for integrating product authenticity verifications into product listings in real (offline) and/or virtual (online) marketplaces is described. Notably, product authenticity verifications may be provided using different authentication techniques and checks of a principal brand. The authenticity check may be a service that is a mediator between a buyer, the brand, and a seller in an online marketplace, and can follow a product through a fulfillment chain (from shipment to a target buyer destination), thereby verifying that the product was not replaced on the way. This authenticity checking service may provide a standard and a secure process that allows a seller of a product and an interested buyer in an online (or offline) marketplace to verify the product authenticity through a trusted third party (usually the brand or manufacturer), without revealing personal information to each other beyond what is necessary for the transaction. Moreover, the authenticity checking service may enable the concept of ‘you get what you buy,’ e.g., what is delivered to you is what you have seen and purchased in a marketplace.

In a first group of embodiments, a computer that performs product authentication is described. During operation, the computer may provide, addressed to the electronic device, information specifying a document at a location in a network, where the document is associated with an online marketplace and comprises second information associated with a product or a service. Moreover, the information may include authentication information that confirms an authenticity of the product or the service, and the authentication is specific (or unique) to the product or the service and the document.

In a second group of embodiments, a computer that performs product authentication is described. During operation, the computer may receive, from the electronic device, a request to authenticate the authenticity of a product, where the request includes information specifying the product. Moreover, the computer may determine the authenticity of the product, where the determining includes providing a set of questions addressed to the electronic device and receiving answers to the set of questions associated with the electronic device, and at least some of the questions in the set of questions are dynamically selected based at least in part on at least some of the answers. Furthermore, the computer may provide, addressed to the electronic device, information specifying the determined authenticity.

In a third group of embodiments, a computer that performs product authentication is described. During operation, the computer may provide, addressed to the electronic device, authentication information for a product, where the authentication information confirms authenticity of the product throughout a fulfillment chain of the product. Note that the fulfillment chain may include display of the product in a document at a location in a network. For example, the document may include a web page or a website. Alternatively or additionally, the authentication information may confirm the authenticity of a displayed instance of the product. Moreover, the authenticity may be invalid when a displayed instance of the product is different from a delivered instance of the product.

By providing end-to-end authentication, these authentication techniques may address the authenticity and trust problems in current online and third-party marketplaces. Moreover, the authentication techniques may ensure or guarantee the authenticity of a product throughout its fulfillment chain, including during purchasing, shipping and receiving. Furthermore, by reducing or eliminating counterfeit or fraudulent products and/or unauthorized distribution of the products, the authentication techniques may facilitate insurance instruments for products. Consequently, the authentication techniques may facilitate improved supply-chain management (e.g., by reducing confusion, errors and/or malicious actions, as well as the associated expenses), and may increase trust in products and the reliability of a variety of marketplaces (such as online marketplaces), which may result in increased commercial activity.

In some embodiments, at least a portion of the authentication techniques may be implemented in a distributed or decentralized manner. Alternatively, in some embodiments, at least a portion of the authentication techniques may be implemented in a centralized manner.

In the discussion that follows, electronic devices may communicate packets or frames with wired and/or wireless networks (e.g., via access points, radio nodes and/or base stations) in accordance with a wired communication protocol (such as an Institute of Electrical and Electronics Engineers or IEEE 802.3 standard, which is sometimes referred to as ‘Ethernet’, or another type of wired interface) and/or a wireless communication protocol, such as: an IEEE 802.11 standard (which is sometimes referred to as ‘Wi-Fi,’ from the Wi-Fi Alliance of Austin, Tex.), Bluetooth (from the Bluetooth Special Interest Group of Kirkland, Wash.), a cellular-telephone communication protocol (such as 2G, 3G, 4G, 5G, Long Term Evolution or LTE, another cellular-telephone communication protocol, etc.) and/or another type of wireless interface. In the discussion that follows, Wi-Fi, a cellular-telephone communication protocol and Ethernet are used as an illustrative example. However, a wide variety of communication protocols may be used. Note that the wireless communication may occur in a variety of frequency bands, such as: a cellular-telephone communication band, a frequency band associated with a Citizens Band Radio Service, a Wi-Fi frequency band (such as a 2.4 GHz, a 5 GHz, a 6 GHz and/or a 60 GHz frequency band), etc.

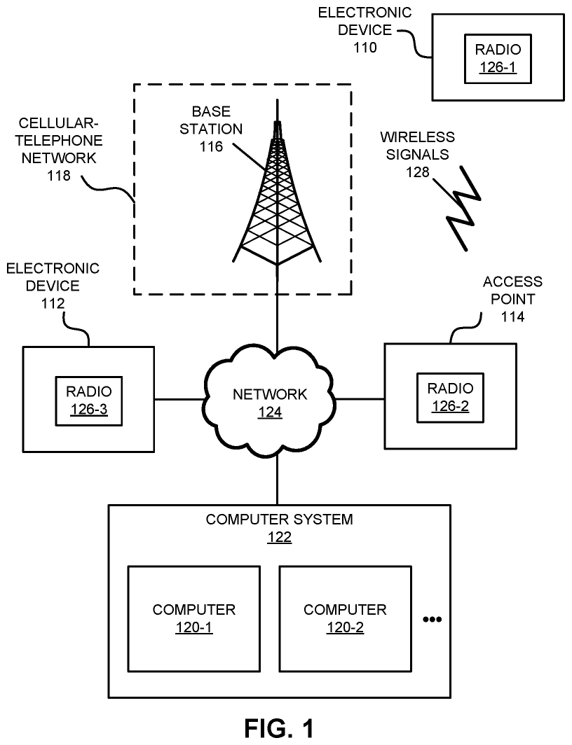

FIG. 1 presents a block diagram illustrating an example of communication among one or more of electronic devices 110 and 112 (such as a cellular telephone, a computer, etc., and which are sometimes referred to as ‘clients’), access point 114, base station 116 in cellular-telephone network 118, and one or more computers 120 in computer system 122 in accordance with some embodiments. Access point 114 and base station 116 may communicate with computer system 122 via network 124 (such as the Internet) using wireless and/or wired communication (such as by using Ethernet or a communication protocol that is compatible with Ethernet), and may communicate with electronic device 110 using wireless communication (Wi-Fi and a cellular-telephone communication protocol, respectively). Note that access point 114 may include a physical access point and/or a virtual access point that is implemented in software in an environment of an electronic device or a computer. In addition, access point 114 and/or base station 116 may communicate with electronic devices 110 using wireless communication, while electronic device 112 may communicate with computer system 122 via network 124.

While not shown in FIG. 1, the wired and/or wireless communication with electronic devices 110 and/or 112 may further occur via an intranet, a mesh network, point-to-point connections, etc., and may involve one or more routers and/or switches. Furthermore, the wireless communication may involve: transmitting advertising frames on wireless channels, detecting one another by scanning wireless channels, establishing connections (for example, by transmitting association or attach requests), and/or transmitting and receiving packets or frames (which may include the association requests and/or additional information as payloads). In some embodiments, the wired and/or wireless communication in FIG. 1 also involves the use of dedicated connections, such as via a peer-to-peer (P2P) communication technique.

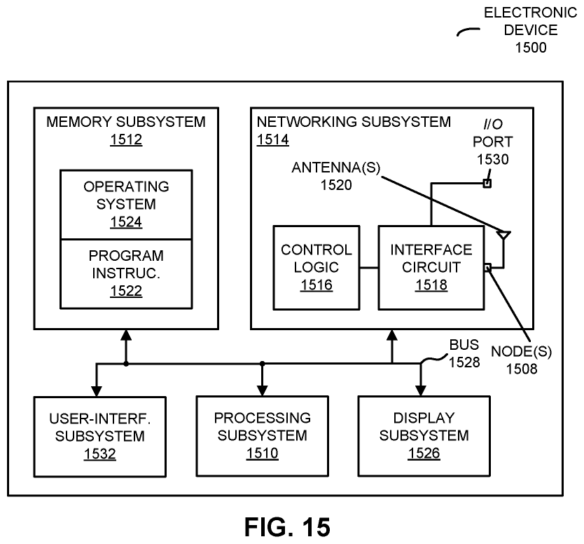

As described further below with reference to FIG. 15, electronic device 110, electronic device 112, access point 114, base station 116, and/or computers 120 may include subsystems, such as a networking subsystem, a memory subsystem and a processor subsystem. In addition, electronic device 110, access point 114 and base station 116 may include radios 126 in the networking subsystems. More generally, electronic device 110, electronic device 112 and access point 114 can include (or can be included within) any electronic devices with the networking subsystems that enable electronic device 110 and access point 114 to communicate with each other using wireless and/or wired communication. This wireless communication can comprise transmitting advertisements on wireless channels to enable access point 114 and/or electronic device 110 to make initial contact or detect each other, followed by exchanging subsequent data/management frames (such as association requests and responses) to establish a connection, configure security options (e.g., Internet Protocol Security), transmit and receive packets or frames via the connection, etc. Note that while instances of radios 126 are shown in electronic device 110 and access point 114, one or more of these instances may be different from the other instances of radios 126.

As can be seen in FIG. 1, wireless signals 128 (represented by a jagged line) are transmitted from radio 126-1 in electronic device 110. These wireless signals may be received by radio 126-2 in access point 114. Notably, electronic device 110 may transmit packets or frames. In turn, these packets or frames may be received by access point 114. Moreover, access point 114 may allow electronic device 110 to communicate with other electronic devices, computers and/or servers via network 124.

Note that the communication among components in FIG. 1 may be characterized by a variety of performance metrics, such as: a received signal strength (RSSI), a data rate, a data rate for successful communication (which is sometimes referred to as a ‘throughput’), an error rate (such as a retry or resend rate), a mean-square error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’).

In the described embodiments processing a packet or frame in electronic device 110 and/or access point 114 includes: receiving signals (such as wireless signals 128) with the packet or frame; decoding/extracting the packet or frame from received wireless signals 128 to acquire the packet or frame; and processing the packet or frame to determine information contained in the packet or frame.

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames.

As discussed previously, it is often difficult to authenticate different products in a consistent and independent manner. In addition, it is often difficult to guarantee that the product purchased by a buyer is in fact the product that is delivered at the intended destination.

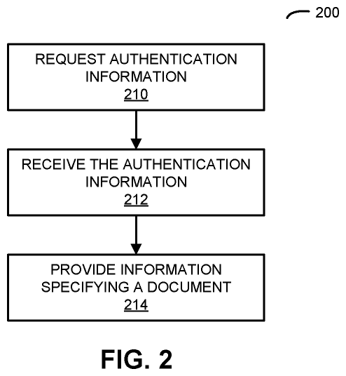

As described further below with reference to FIGS. 2-14, in order to address these problems, the authentication techniques may be used to provide different embodiments. For example, as discussed further with respect to FIGS. 2-3 and 8-9, the authentication techniques may be used to provide authentication as a service. For example, a computer (such as computer 120-1) may request authentication information from electronic device 112 (which may be associated with a manufacturer or a provider of the product) that confirms an authenticity of a product or a service, where the authentication is specific to the product or the service and a document at a location in a network. For example, the document may include a web page or a website, and the network may include an intranet or the Internet.

In response, electronic device 112 may provide the authentication information to computer 120-1. For example, the authentication information may include a unique code (which may be based at least in part on the document, a layout of the document, or a structure of the document) or a link to another location in the network with the unique code. Alternatively or additionally, the unique code may be based at least in part on a second unique code associated with the product or the service. Note that the second unique code may be associated with a manufacturer or a provider of the product or the service.

After receiving the authentication information, computer 120-1 may provide information to electronic device 110 (which may be associated with a purchaser or an interested buyer of the product). This information may specify the document at the location in the network, where the document is associated with an online marketplace and includes second information associated with the product or the service and the authentication information.

Note that when the document is changed (e.g., the layout or the structure of the document), the authentication information may be invalidated. Similarly, the authentication information may be specific to computer 120-1, so that changes may result in the authentication information being invalidated.

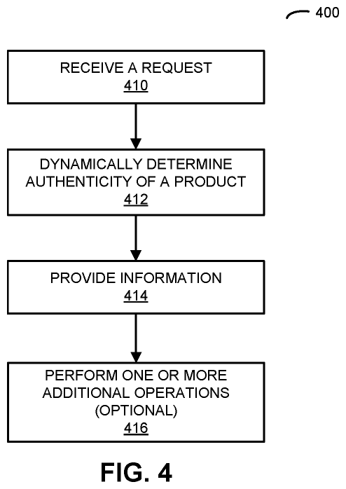

Moreover, as discussed further with respect to FIGS. 4-5 and 10-12, the authentication techniques may be used to provide a dynamic auto-adjusted authentication discovery/learning process application programming interface (API). For example, a computer (such as computer 120-1) may provide this dynamic API. Notably, computer 120-1 may receive a request from electronic device 110 to authenticate authenticity of a product, where the request includes information specifying the product. Note that the product may have been manufactured before the existence of an authentication service associated with the computer.

In response, computer 120-1 may dynamically determine the authenticity of the product, where the determining includes providing a set of questions to electronic device 110-1 and receiving answers to the set of questions from electronic device 110-1, and at least some of the questions in the set of questions are dynamically selected by computer 120-1 based at least in part on at least some of the answers. Then, computer 120-1 may provide information to electronic device 110-1 specifying the determined authenticity.

In some embodiments, the authenticity may be determined by computer 120-1 using a group of predefined authentication modules that are selected by computer 120-1 based at least in part on the product. In some embodiments, the group of predefined authentication modules may include a pre-trained machine-learning model. Alternatively or additionally, a sequence of the group of predefined authentication modules may be selected by computer 120-1 based at least in part on the product.

Note that the pre-trained machine-learning model may have been trained using a machine-learning technique, such as a supervised-learning technique. For example, the supervised-learning technique may include: a classification and regression tree, a support vector machine (SVM), linear regression, nonlinear regression, logistic regression, least absolute shrinkage and selection operator (LASSO), ridge regression, a random forest, and/or another type of supervised-learning technique. In some embodiments, the pre-trained machine-learning model may include a pre-trained neural network, such as a convolutional neural network or a recurrent neural network.

Furthermore, the authenticity may be determined by computer 120-1 based at least in part on a context of the authentication. For example, the context may include a document in a network that is offering the product. Note that the document may include: a location of the document; and/or a web page or a website. Alternatively or additionally, the context may include: a number of authentication attempts for the product; a location in a network of electronic device 110-1, which is purchasing the product (or is used by a purchaser of the product); and/or an authentication history of a purchaser of the product.

In some embodiments, the set of questions may include a request for information associated with a label of the product. For example, the information may include an image of the label. Note that the determining may include analyzing the label to identify random markings at different locations in the label.

Note that the label may include unique identifier that is compatible with: a global standards 1 (GS1) digital link, a global trade item number (GTIN), a serial shipping container (SSCC), a serialized global trade item number (SGTIN), an European article number code (EAN), a universal product codes (UPC), an electronic product code (EPC), a global location number (GLN), an international standard book identifier (ISBN), a global returnable asset identifier (GRAI), a global coupon number (GCN), an Amazon standard identification number (ASIN), a global returnable asset identifier (GRAI), a global shipment identification number (GSIN), a universally unique identifier (UUID), a global document type identifier (GDTY), a globally unique identifier (GUID), an Eddystone UID or EID, an international mobile equipment identity (IMEI), an eSIM identifier, a pharmaceutical product identifier (PhPID), a serial number, a blockchain address, a blockchain transaction identifier, a hash table, a blockchain token, an ERC721 token, a non-fungible token, and/or a public key. In some embodiments, a unique identifier may be a random or a pseudo-random number.

Moreover, the image may be analyzed using an image-processing or image-analysis technique, including: an edge or a line-segment detector, a texture-based feature detector, a texture-less feature detector, a scale invariant feature transform (SIFT)-like object-detector, a speed-up robust-features (SURF) detector, a binary-descriptor (such as ORB) detector, a binary robust invariant scalable keypoints (BRISK) detector, a fast retinal keypoint (FREAK) detector, a binary robust independent elementary features (BRIEF) detector, a features from accelerated segment test (FAST) detector, and/or another image-processing or image-analysis technique. Alternatively or additionally, in some embodiments the image may be analyzed using a pre-trained neural network.

Moreover, the determining by computer 120-1 may include requesting information from a counterparty to a party associated with electronic device 110-1 in a transaction associated with the product. For example, the counterparty may use electronic device 112. Furthermore, computer 120-1 may provide instances of a common user interface to the party and the counterparty (i.e., to electronic devices 110 and 112) during the determining. Thus, the party or the counterparty may respectively use or interact with a given instance of the common user interface during the determining. Additionally, the determining by computer 120-1 may include requesting information from a manufacturer of the product.

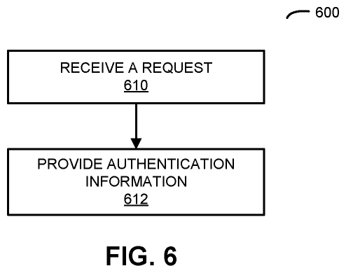

Furthermore, as discussed further with respect to FIGS. 6-7 and 13-14, the authentication techniques may be used to provide a ‘you get what you buy/see’ capability. For example, a computer (such as computer 120-1) may receive, from electronic device 110, a request for authentication information for a product. In response, computer 120-1 may provide, to electronic device 110, the authentication information for the product, where the authentication information confirms authenticity of the product throughout a fulfillment chain of the product.

Note that the fulfillment chain may include display of the product in a document at a location in a network, such as a web page or a website. Alternatively or additionally, the authentication information may confirm the authenticity of a displayed instance of the product. Moreover, the authenticity may be invalid when a displayed instance of the product is different from a delivered instance of the product. Furthermore, the fulfillment chain may include delivery of the product at a destination address of a purchaser.

Additionally, the authentication information may confirm that the product is unchanged throughout the fulfillment process.

In some embodiments, the fulfillment chain may include one or more instances of packaging the product. For example, the product may be repacked or transferred into different physical containers during the fulfillment chain.

In these ways, computer system 122 may provide end-to-end authentication of a product (or a service) in an online or a physical marketplace. Thus, the authentication techniques may ensure or guarantee the authenticity of a product. Consequently, the authentication techniques may reduce or eliminate fraud and, thus, may reduce the associated costs. Therefore, the authentication techniques may enhance trust in the instances of the product, and in marketplaces that sell or conduct commercial transactions that include or involve the product.

While the preceding embodiments illustrated the authentication techniques being implemented via a cloud-based computer system 122, in other embodiments at least some of the aforementioned operations may be performed locally on, e.g., electronic device 110 or 112. Thus, operations in the authentication technique may be performed locally or remotely.

We now describe embodiments of a method. FIG. 2 presents a flow diagram illustrating an example of a method 200 for authenticating a product or a service using a computer, such as one or more computers 120 in computer system 122 (FIG. 1). During operation, the computer may request, addressed to an electronic device, authentication information (operation 210) that confirms an authenticity of a product or a service, where the authentication is specific to the product or the service and a document at a location in a network. Moreover, the document may include a web page or a website. Furthermore, the network may include the Internet.

In response, the computer may receive, associated with the electronic device, the authentication information (operation 212).

Then, the computer may provide, addressed to a second electronic device, information specifying the document (operation 214) at the location in the network, where the document is associated with an online marketplace and includes second information associated with the product or the service and the authentication information.

Note that the authentication information may be based at least in part on a layout or a structure of the document. For example, when the document changes, the authentication information may be invalidated.

Additionally, the authentication information may be specific to the computer. In these embodiments, when the document changes, the authentication information may be invalidated.

In some embodiments, the authentication information may include a unique code. Alternatively or additionally, the authentication information may include a link to another location in the network with the unique code. The unique code may be based at least in part on the document, a layout of the document, or a structure of the document, and may be based at least in part on a second unique code associated with the product or the service. Note that the second unique code may be associated with a manufacturer or a provider of the product or the service. In some embodiments, the second unique code may be based at least in part on a hash function.

In some embodiments of method 200, there may be additional or fewer operations. Furthermore, the order of the operations may be changed, there may be different operations and/or two or more operations may be combined into a single operation.

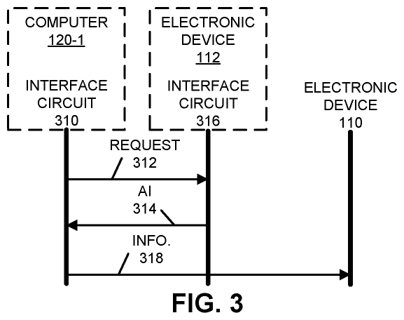

FIG. 3 presents a drawing illustrating an example of communication among electronic device 110, electronic 112 and computer 120-1. During the authentication techniques, an interface circuit 310 in computer 120-1 may request 312 authentication information (AI) 314 from electronic device 112 (which may be associated with a provider or a manufacturer or a product or a service). This authentication information may confirm an authenticity of the product or the service, where the authentication is specific to the product or the service and a document (such as a web page or a website) at a location in a network (such as the Internet, an intranet, etc.).

After receiving request 312, an interface circuit 316 in electronic device 112 may provide authentication information 314 to computer 120-1. Moreover, after receiving authentication information 314, interface circuit 310 may provide to electronic device 110 information 318 specifying the document at the location in the network. Note that the document may be associated with an online marketplace and may include second information associated with the product or the service and authentication information 314.

While FIG. 3 illustrates communication between components using unidirectional or bidirectional communication with lines having single arrows or double arrows, in general the communication in a given operation in these figures may involve unidirectional or bidirectional communication.

FIG. 4 presents a flow diagram illustrating an example of a method 400 for authenticating a product or a service using a computer, such as one or more computers 120 in computer system 122 (FIG. 1). During operation, the computer may receive, from an electronic device, a request (operation 410) to authenticate authenticity of a product (or a service), where the request includes information specifying the product. Note that the product may have been manufactured before the existence of an authentication service associated with the computer.

In response, the computer may dynamically determine the authenticity of the product (operation 412), where the determining includes providing a set of questions addressed to the electronic device and receiving answers to the set of questions associated with the electronic device, and at least some of the questions in the set of questions are dynamically selected based at least in part on at least some of the answers.

Furthermore, the computer may provide, addressed to the electronic device, information (operation 414) specifying the determined authenticity.

In some embodiments, the computer may optionally perform one or more additional operations (operation 416). For example, the authenticity may be determined using a group of predefined authentication modules that are selected based at least in part on the product. In some embodiments, the group of predefined authentication modules may include a pre-trained machine-learning model. Alternatively or additionally, a sequence of the group of predefined authentication modules may be selected based at least in part on the product.

Furthermore, the authenticity may be determined based at least in part on a context of the authentication. For example, the context may include a document in a network that is offering the product. Note that the document may include: a location of the document; and/or a web page or a website. Alternatively or additionally, the context may include: a number of authentication attempts for the product; a location in a network of the electronic device, which is purchasing the product; and/or an authentication history of a purchaser of the product.

In some embodiments, the set of questions may include a request for information associated with a label of the product or an image of a proof of purchase/authenticity certificate. For example, the information may include an image of the label. Note that the determining may include analyzing the label to identify random markings at different locations in the label. Moreover, the determining may include requesting information from a counterparty to a party associated with the electronic device in a transaction associated with the product. Furthermore, the computer may provide instances of a common user interface to the party and the counterparty during the determining. Additionally, the determining may include requesting information from a manufacturer of the product.

In some embodiments of method 400, there may be additional or fewer operations. Furthermore, the order of the operations may be changed, there may be different operations and/or two or more operations may be combined into a single operation.

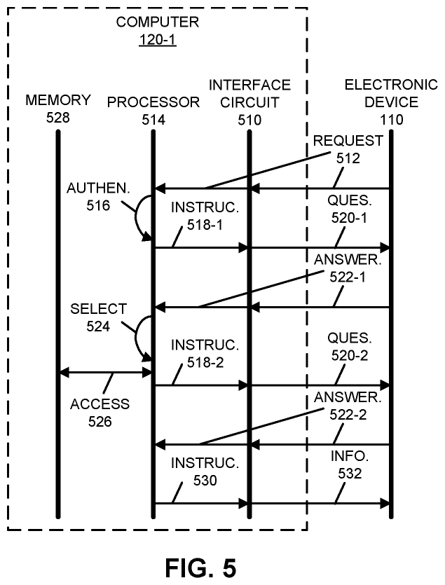

FIG. 5 presents a drawing illustrating an example of communication among electronic device 110 and computer 120-1. During the authentication techniques, an interface circuit 510 in computer 120-1 may receive a request 512 from electronic device 110 to authenticate authenticity 516 of a product, where request 512 includes information specifying the product. Interface circuit 510 may provide request 512 to a processor 514 in computer 120-1.

Then, processor 514 may dynamically determine authenticity 516 of the product. During the determining, processor 514 may instruct 518 interface circuit 510 to provide a set of questions 520 (which may be associated with a group of predefined authentication modules) to electronic device 110 and to receive answers 522 to the set of questions 520 from electronic device 110 (or a user of electronic device 110). Note that in some embodiments interface circuit 510 may provide at least some of answers 522 to processor 514 as at least some of answers 522 are received. Consequently, in some embodiments, processor 514 may dynamically select 524 at least some of the questions in the set of questions 520 based at least in part on at least some of answers 522. For example, processor 514 may access 526 selected questions 520-2 from memory 528 in computer 120-1.

Next, processor 514 may instruct 530 interface circuit 510 to provide, addressed to electronic device 110, information 532 specifying the determined authenticity 516.

While FIG. 5 illustrates communication between components using unidirectional or bidirectional communication with lines having single arrows or double arrows, in general the communication in a given operation in these figures may involve unidirectional or bidirectional communication.

FIG. 6 presents a flow diagram illustrating an example of a method 600 for authenticating a product or a service using a computer, such as one or more computers 120 in computer system 122 (FIG. 1). During operation, the computer may receive, associated with an electronic device, a request (operation 610) for authentication information for a product. In response, the computer may provide, addressed to the electronic device, the authentication information (operation 612) for the product, where the authentication information confirms authenticity of the product throughout a fulfillment chain of the product.

Note that the fulfillment chain may include display of the product in a document at a location in a network. For example, the document may include a web page or a website. Alternatively or additionally, the authentication information may confirm the authenticity of a displayed instance of the product. Moreover, the authenticity may be invalid when a displayed instance of the product is different from a delivered instance of the product. Furthermore, the fulfillment chain may include delivery of the product at a destination address of a purchaser.

Additionally, the authentication information may confirm that the product is unchanged throughout the fulfillment process.

In some embodiments, the fulfillment chain may include one or more instances of packaging the product.

In some embodiments of method 600, there may be additional or fewer operations. Furthermore, the order of the operations may be changed, there may be different operations and/or two or more operations may be combined into a single operation.

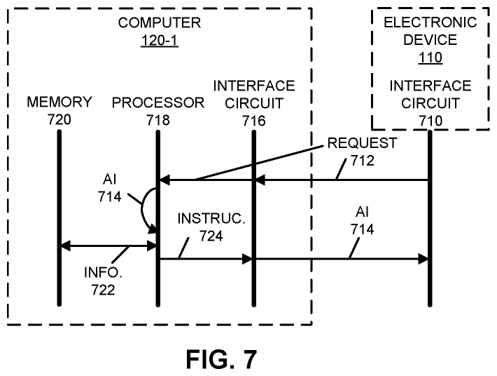

FIG. 7 presents a drawing illustrating an example of communication among electronic device 110 and computer 120-1. During the authentication techniques, an interface circuit 710 in electronic device 110 may provide to computer 120-1 a request 712 for authentication information 714 for a product.

After receiving request 712, interface circuit 716 in computer 120-1 may provide request 712 to processor 718 in computer 120-1. Processor 718 may determine authentication information (AI) 714, where authentication information 714 confirms authenticity of the product throughout a fulfillment chain of the product. For example, processor 718 may access predetermined or predefined information 722 in memory 720 in computer 120-1 and/or may dynamically determine authentication information 714 based at least in part on information included in request 712.

Then, processor 718 may instruct 724 interface circuit 716 to provide, addressed to electronic device 110, authentication information 714 for the product.

While FIG. 7 illustrates communication between components using unidirectional or bidirectional communication with lines having single arrows or double arrows, in general the communication in a given operation in these figures may involve unidirectional or bidirectional communication.

We now further describe embodiments of the authentication technique. In the present discussion, a ‘commercial transaction’ may include selling a product or a service for a monetary value, which may be paid with credit, a credit or debit card, or a financial instrument (such as money). Alternatively, in some embodiments, a ‘commercial transaction’ may include barter for an equivalently valued product or service.

Moreover, in the discussion that follows, a ‘marketplace’ may include a platform (such as an online platform, e.g., an e-commerce platform, a second-hand listing site, etc.) that lists products. Products are often re-sold on marketplaces, either by their owners or by brokers. These are also known as secondary/third-party marketplaces, e.g., an online sale by a marketplace that is a third party to the brand owner, and which may involve a seller who is potentially a third party to the marketplace. Furthermore, online and/or virtual marketplaces present information that is filtered by the owner of the marketplace, and the association between a product sold to a buyer and the actual product received by the buyer does not exist. Instead, the buyer typically needs to trust the seller without independent evaluation or assertion of purchasing authenticity.

However, a large number of products sold on these platforms are not genuine. This is especially true in high-end markets, such as the luxury goods market. Fraudulent or counterfeit products that are misrepresented result in uncertainty in these marketplaces. Notably, the entire industry often has the following problems: the end-user buyer is uncertain about the product received; the marketplace has a potential liability to the brand owner; the brand owner has a threat to the integrity of their brand and lost revenues because of the sale of counterfeit products; and the variations in the product display context can adversely impact perception of product veracity.

The disclosed authentication techniques address these shortcomings by providing a system through which marketplaces, real (or physical) or virtual (such as online), can integrate product authenticity verifications to their listings by using different authentication techniques and checking the principal brand. An authenticity check service may be a mediator between the buyer, the brand, and the seller on an online marketplace, and can follow the product through shipment to the target buyer destination, thereby verifying that the product was not replaced on the way. This service may provide a standard and a secure process that allows a seller of a product and an interested buyer in an online (or an offline) marketplace to verify the product authenticity through a trusted third party (usually the brand or manufacturer), without revealing personal information to each other beyond what is necessary for the transaction. Moreover, the service may enable the concept of ‘you get what you buy,’ e.g., what is delivered to you is what you have seen online in a marketplace.

In the embodiments of authentication as a service, a unique association is encoded between a product to a website, a web page and/or a display that lists this product. This association may enable offline/online and dynamic authentication when displayed, and may logically link an authenticated product to an online or a physical display.

Moreover, changes to the displayed information may trigger re-authentication of the product in order for the display to maintain its approval authentication level. In this feature of the authentication techniques, a display change may force another instance of an authentication process. Note that changes may include, but are not limited to, web-page links, which in turn prevent online fraud, while enabling stronger online security based at least in part on an association between a display and a physically unique authenticated product.

Furthermore, the display may include a user-interface element that manages proof of authenticity for this web page and its purchasable items. For example, the presence of the user-interface element may indicate that the associated displayed product has been authenticated (and, thus, is authentic). Additionally, an online certificate of authenticity may be used in online advertisement and may be linked (one-to-one) to the correct online marketplace display. Note that the certificate may include a hashing of the web page and an advertisement of the product with the product authentication.

In some embodiment, distributed ledger is used for the on-line proof of authenticity. For example, a hashed subset of a web page (the portion with the body of a listing) may be used with a public blockchain, either directly or in a Merkle tree for cost optimization. (More generally, hashing of the subset of the web page with a unique code or identifier associated with the product may be used. For example, the unique code may include a predefined random or pseudo-random number that is uniquely associated with the product.) This capability may ensure that the listing was not modified. Thus, an authenticated product from one brand cannot be listed as if it were a different brand.

In embodiments of a dynamic auto-adjusted authentication discovery/learning process API, the authentication process may be based at least in part on authentication modules. These authentication modules may be attached or used dynamically during the authentication process based at least in part on answers to discovery questions.

In some embodiments, the authentication modules may include one or more authentication modules that are specific to the product and that can prompt a user or an authenticator for different activities, including: who is authenticating?; who is asking or initiated the process?, etc. Note that the prompts can be based at least in part on a stock-keeping unit (SKU), such as the type of product. More generally, the prompts may be based at least in part on one or more unique identifiers of the product, which may be included in a request to authenticate the product.

Moreover, the computer system performing the authentication may provide or prompt questions to identify the product based at least in part on what the user wishes to authenticate to, such as ‘this looks like a watch from brand A, would you like to authenticate it as a brand-A product?’ Note that the computer system may provide different questions depending on a type of user or individual. For example, the computer system may provide a different set of questions based at least in part on an identifier associated with a user (such as a username and password associated with a brand inspector versus a customer). Moreover, the set of questions may include: asking a user for details about a product (e.g., what letters are printed on the third button); and/or prompting for a picture of the product with a proof of a timestamp (e.g., a picture of a front-page of a newspaper).

Furthermore, the authentication modules may be generic to begin with, but also may be assigned and trained by the manufacturer and may reside on their website. The authentication modules may be aligned to or uniquely associated with the product using a unique combination of features or inputs that the manufacturer can choose and control. Additionally, a hashing or combination of the features or inputs may be of the authentication process operations and inputs, such that any re-run results in the same authenticity value (which may be binary or real-valued).

For example, the authentication modules may include a product-class reader that may read the product class from a barcode or a code on the label (such as a unique identifier of the product). The ‘reading’ may using scanning technology, image recognition (such as an image-processing or image-analysis technique), optical character recognition (OCR), a pre-trained neural network and/or by prompting the user for a code. Alternatively or additionally, a serial code reader may be used to read a serial code on the product, such as: a purchase order code, a serial code unique to the item, a serialized warranty card, a unique identifier of the product, etc. In some embodiments, the authentication modules may include a radio-frequency identifier (RFID) code reader, which may prompt a user to tap their electronic device (such as a cellular telephone) on a near-field-communication (NFC) tag or portion of a product in order to wirelessly sense information associated with the product. Note that a relational authentication module may ask for scanning the pack, box and/or the item.

Furthermore, the authentication modules may include a material fingerprinting module, which may use high-resolution images of a particular part of an item or product in order to recognize the patterns of the material.

Additionally, the authentication modules may include a proxy module that redirects computer 120-1 to a brand website associated with the product for part of the authentication. For example, the proxy module may have computer 120-1 provide proxy identification information associated with the product to a brand product identification system. During these operations, computer 120-1 may login to the brand product identification system as a user or a brand inspector.

In some embodiments, one or more of the authentication modules may: prompt for a picture or an image of the product with a proof of a timestamp (e.g., a picture of the front-page of a newspaper); request information specifying a user location (such as information associated with a global positioning system or GPS, an Internet Protocol or IP address of an electronic device associated with the user, etc.); ask a user for detail(s) about the product (e.g., what letters are printed on the third button?); and/or use audio information to perform acoustic matching of a user or background noise (such as noise, music, a language being spoken, etc. at a marketplace) at a location where the product is supposed to be located. For example, an authentication module may use a voice recognition technique. In these embodiments, an authentication module may ask specific questions regardless of the product/object in question in order to record a voice signature, which may used to confirm the identity of a user.

In embodiments of you get what you buy/see capability, in addition to a product authentication hash code, the end user (or buyer) may sign the purchased product on the website as part of the purchasing process. This signature may be added to the product authentication hashing. For example, there may be a single code that includes the signature information of the user. Subsequently, when receiving the product, a new owner may check its authenticity using their part of the signature key pair with the authentication authority.

The disclosed authentication techniques may include at least several aspects. First, the authentication techniques may act as or provide a proxy in front of authenticity check systems, such as those owned by brands, e.g., luxury brands. Instead of merchants having to deal with dozens of different systems for each type of product, this front end may provide a uniform user interface that allows merchants to interact with a single system (such as computer system 122 in FIG. 1). In some embodiments, this single system may delegate the authenticity determination for a given product to a particular brand. For sellers and buyers, this capability has the advantage of a trusted third party that has an incentive to prevent the sale of counterfeit products.

Moreover, in some embodiments, the disclosed authentication techniques may add a shared secret between the buyer and the authenticator, such that the buyer can authenticate the product when it is received with information that only the buyer knows. In order for a shared secret to be enabled, product authenticity may be established. The authentication techniques may create and maintain a dynamic and unique relationship between a product and a buyer throughout the purchasing or fulfillment process, which is independent of the product and that has full support for the entire product lifecycle (e.g., including second-hand marketplaces).

Furthermore, the disclosed authentication techniques may also specify or provide an intelligent workflow manager that distributes the authentication process based at least in part on vendor-specific flows and/or a common local context. This manager may choose which discrete authentication modules (e.g., a scan of a serial code, taking a picture of the item, contacting a particular authenticity check service from a brand, etc.) needs to be coupled together, and in what order, in order to successfully assess the authenticity of a product. For example, a specific sequence of authentication modules may be selected for a product based at least in part on: its location, a timestamp, a value of the product, an estimated frequency of fraudulent activity associated with other instances of the product, etc. This capability may create an accountable, secure, and online-marketplace independent service that acts as a trusted third party for product authentication and frees the merchants from managing and maintaining a catalog of authentication workflows. The intelligent workflow manager can be configured for brands to update their product inventory after the fact, e.g., in order to take into account products that were lost or stolen, products that were sold before the supply chain was digitized, and/or in order to take into account or adapt to evolutions in counterfeiting techniques.

Additionally, the disclosed authentication techniques provide a system (such as computer system 122 in FIG. 1) and protocol API that can be used by real or virtual marketplaces to integrate authenticity verification into their listings by combining different authentication technologies, such as: callbacks, digital signatures, and/or distributed ledgers.

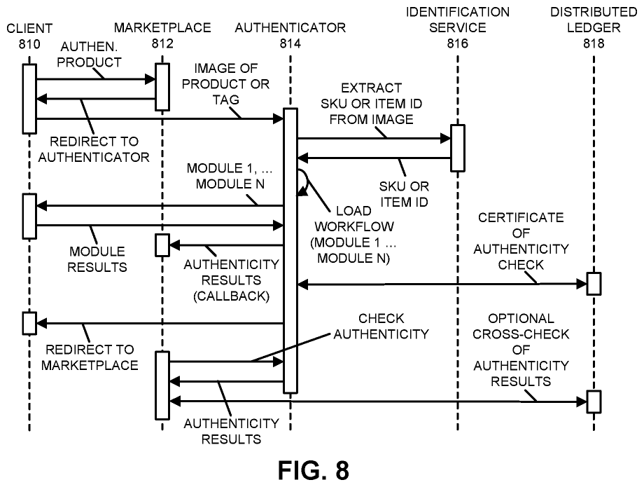

FIG. 8 presents a drawing illustrating an example of communication among electronic devices in FIG. 1 during the authentication techniques. This figure shows a high-level overview of an example of a system and a protocol API for marketplace authenticity verification. In these embodiments, the authentication is triggered by a client 810, who is redirected to an authenticator 814, which may extract a SKU from an item (or a product) and may dynamically load a set authentication modules or workflow[s] for the subsequent authentication process. Once the authentication modules have completed their work, the results may be directed to marketplace 812 and client 810 may also be redirected to marketplace 810. The results may be stored in a distributed ledger 818. Note that the authenticity result provided to marketplace 812 may not limited to a single format, but may have a variety of formats or codes, such as a hash, encrypted figure, electronic signature, etc.

Keeping the results in distributed ledger 818 and including a certification of the check and the associated organization (such as marketplace 812 and/or client 810) may keep the parties locked or closed off and may prevent fraud. Once client 810 is redirected to marketplace 812, the authentication check loop is closed. In some embodiments, there may be an optional update to distributed ledger 818 whenever there is an authenticity check request by marketplace 812 or other clients.

Note that authentication as a service may require a tight correlation between the product or object being sold and the electronic display, which can be hardware, software or a combination, such as a website, a web page, etc. The same product can be present on multiple displays at the same time and the same correlation may be required to make sure that a ‘man in the middle’ attack is averted, while maintaining unique authenticity of the object and establishing trust between buyers and sellers.

This system may establish a shared secret between (online) marketplace 812 and the authenticating entity. In some embodiments, a shared secret is established via exchange of public keys and by using a Diffie Hellman (DH) technique to independently derive a shared secret between any two or more entities. DH is one embodiment and the authentication techniques are not limited to this specific technique, only that a plurality of secrets may be established, and potentially communicated over non-secured communication links between two or more entities. Specifically, in the authentication techniques the plurality of secrets may be between online marketplace 812 and an authentication service provider that provides an authentication service 816. Note that authentication service provider may be referred to as an ‘on-line authentication server,’ which can authenticate an object or product.

In order to provide authentication as a service, ‘how’ the authentication process is executed is not important, only that it exists and can be represented by a cypher or a cypher code, such as, but not limited to, a plurality of non-fungible hash codes.

This leads us to a second element in the authentication techniques, notably, having an authenticated object (such as a product). In some embodiments, the authentication operations/activities and the results from each operation may be captured as part of a plurality of hash code[s] generated by the techniques. There may be a plurality of authentication techniques, and each may generate a plurality of authentication operations that results in a plurality of hash codes that can be combined into a single code that represents the operations, their sequence and the results. In some embodiments, the authentication operations/activities and their results and sequences may be part of online distributed ledger 818 that contains the necessary data and is uniquely coded for access via a single non-fungible hash code.

Once the shared secret has been established, the authentication of an object may begin with a request issued by online marketplace 812. Online marketplace 812 may use the shared secret to assert its identity and submit objects/products for authentication. If the authentication operation of a product/object fails for any given product, there may not be anything more that needs to be done, but to report back to online marketplace 812.

Assuming that the products/object are successfully authenticated, then a computer that implements authentication service 816 may provide a unique code to be placed on or included in the document (such as the website/display) with a link that includes a unique hash code that is the combination or function of the web-page detail and the authentication hash code.

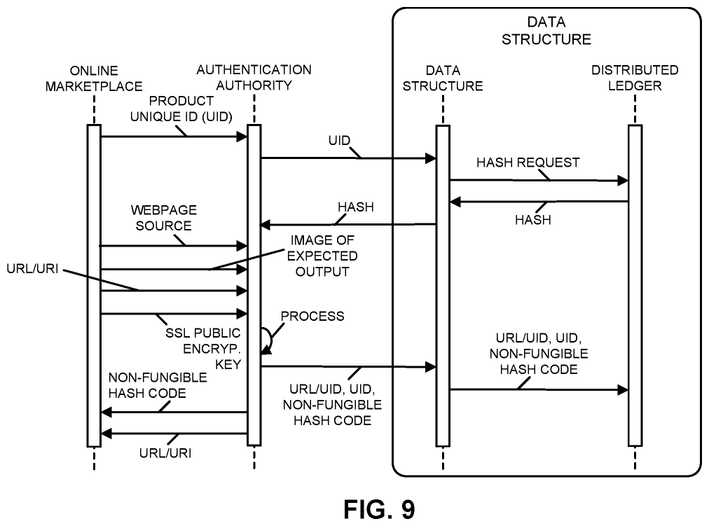

Details on how the unique hash code may be determined or established are shown in FIG. 9, which presents a drawing illustrating an example of communication among electronic devices in FIG. 1. Notably, FIG. 9 depicts an example of a process to create a unique hash code or uniform resource identifier (URI) for an already authenticated product for a specific online marketplace.

In this process, inputs may include: at least a portion of web-page source code (which may include information that will be downloaded to the client browser, limited by the object layout); an image of the expected output; and/or a uniform resource locator (URL), URI, and/or a secure sockets layer (SSL) public key to the source of each link on the web page. Moreover, outputs from the process in FIG. 9 may include a non-fungible hash of the inputs with the product/object authenticity hash, which in turn may create a unique association between the display or the displayed information and the product/object. The hashing technique for the combined code may remove known code(s) from the web page prior to the hashing operation in order to avoid placement sequence issues and to allow fully distributed processing. In some embodiments, the hash code may include a URI that, once activated, invokes a verification of the display or the displayed information, its location and codes, and/or the authenticated object.

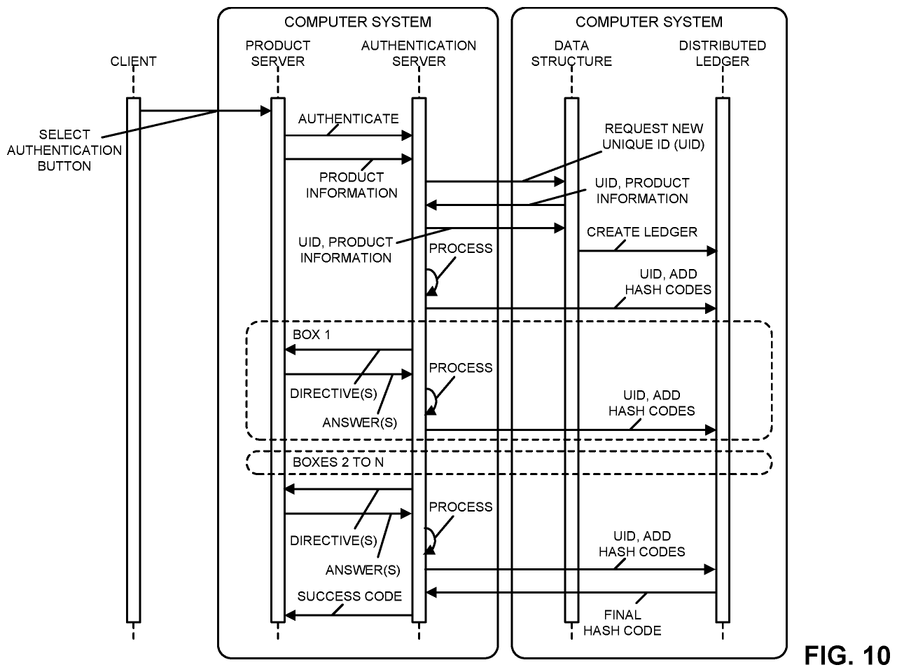

The dynamic auto-adjusted authentication discovery/learning system is shown in FIG. 10, which presents a drawing illustrating an example of communication among electronic devices in FIG. 1. In this dynamic and auto-adjusted authentication discovery/learning system, the authentication may be subdivided into reusable authentication modules. In some embodiments, the authentication modules may include: SKU reading, reading random numbers of a product label, identifying random dots around the label, a client-mobile authentication history (such as a history of authentication attempts associated with a particular electronic device associated with a user), a client mobile location, and/or a source IP address of the marketplace website. Note that a given authentication module may ask for more information from the authenticator. Moreover, a given question and answer may provide a confidence level marker/indication, which in some embodiments can be an integer between {0, 100} or a real number between {0,1}.

Thus, in some embodiments, the authentication process may be based at least in part on one or more authentication modules. These authentication modules may be dynamically attached or included in the authentication flow during the authentication process based at least in part on answers to discovery questions. What this means is that the sequence of these authentication modules may be unique to the object being authenticated in the context of the authentication environment and the online marketplace. When there is a change, the authentication may become invalid. For example, the change may include a change in the online marketplace URL, the physical location, a number of tries or attempts to authenticate the same/similar product, etc. Such changes can impact the questions asked/the information required and the processing operations and the authentication results. Capturing the authentication modules used in sequence, and the questions and results during the process allow add another level of authentication to be captured that is independent of the authentication modules themselves.

In some embodiments of the authentication techniques, one or more of the authentication modules may be designed by a manufacturer of a particular product. In this way, a product can have specific information that can be scanned or revealed by the authenticator and that is known only to the original manufacturer of the product. For example, the specific information may include: random numbers in a label; a purchase order; random dots located at different positions around or on the label; and/or marketplace authentication relative to an authorized resellers database.

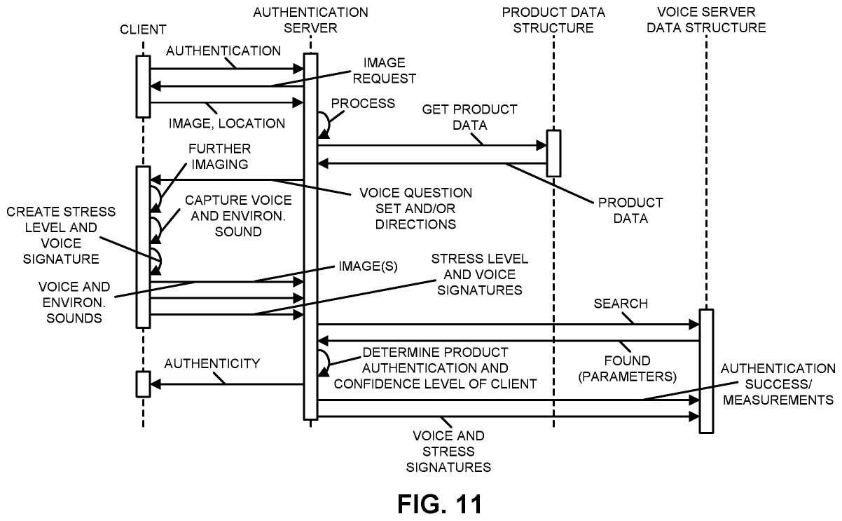

Moreover, in some embodiments, the authentication may be influenced by or may use a voice and/or a stress signature. This is shown in FIG. 11, which presents a drawing illustrating an example of communication among electronic devices in FIG. 1. Notably, this capability may be provided by an authentication module that collects and uses this information during the authentication process. For example, a stress level in the voice of a user and/or an associated voice signature of the user may be used during a given authentication instance and/or in future authentication instances performed by a given user. More general, the authentication techniques may use one or more biometrics (such as a fingerprint, a palm print, a pattern of veins, a retinal pattern, etc.) during an instance of authentication.

Another aspect of the authentication techniques may include separately training a machine-learning or a neural-network model to associate or increase/decrease a probability of authenticity relative to the stress level and/or voice signature of the authenticator. This capability, in combination with one or more other authentication techniques such as used in one or more of the authentication modules, may provide a better probability of authentication. Furthermore, if a user is not authenticated, their voice and stress signature may be retained for future instances of authentication transactions. These retained signatures may be used to identify repeat offenders that are attempting to authenticate any number of products (e.g., the same product or different products).

As shown in FIG. 11, the authentication techniques may use an authentication confidence and a user (or biometric) confidence for product authentication. The perimeters for authentication may be shared with a voice history data structure or database for future use and may include the number of times a product is authenticated, a number of successful authentications, a number of authentication failures, and/or the voice and/or stress signatures. Over time, the machine-learning and/or the neural-network model may use this data to learn interactions and associate or correlate voice signatures and/or voice stress levels with product authentication

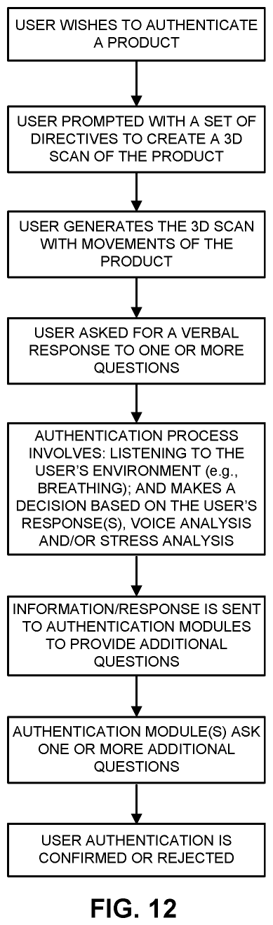

Another embodiment of the use of authentication confidence and user (or biometric) confidence during authentication of a product is shown in FIG. 12, which presents a flow diagram illustrating an example of a method for authenticating a product or a service using a computer of FIG. 1.

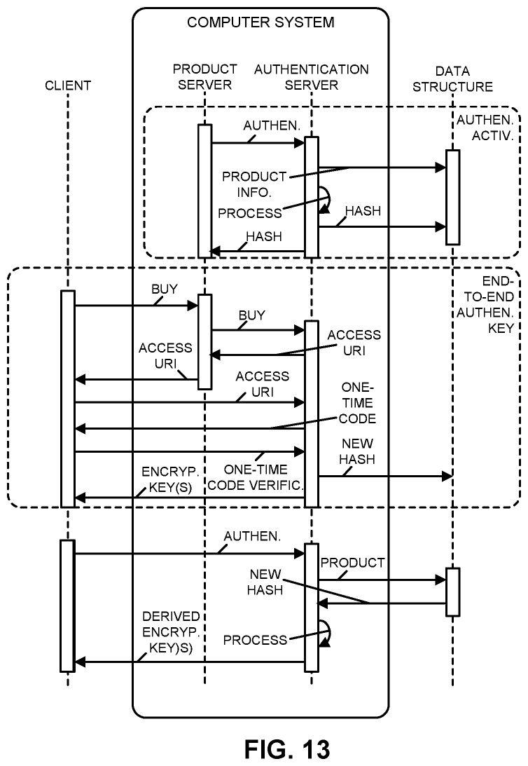

An embodiment of a you get what you buy/see capability is shown in FIG. 13, which presents a drawing illustrating an example of communication among electronic devices in FIG. 1. Notably, product authentication and key generation may occur prior to a client purchase. A product server, which is sometimes referred to as an ‘online-marketplace server,’ may register a product with an authentication server, which in turn may authenticate the product and generate a hash key that is derived or based at least in part on product authenticity and the online-marketplace display details (as described previously in the discussion of FIG. 9).

When a client asks to buy or purchase the product, a buy request may be provided to the online marketplace server, which in turn forwards the request to the authentication server with information that identifies the buyer. This buyer information may include credit or debit card information, or something that the buyer can uniquely report when asked in the future (e.g., a unique identifier of the buyer). The authentication server may retrieve the authentication information hash from the data structure or database server and may use the unique input of the buyer to create a new hash that represents/encodes the product, the online marketplace display, and the customer/buyer information. The encoding may be such that, when a mathematical operation is performed on the hash using the product authentication information and the client unique information, a specific code may be obtained. This code may be shared with the buyer and then may be removed from the system.

When the customer receives the product, they may authenticate the received product using the authentication server. This authentication process may include providing a unique identifier used when purchasing the product. The authentication server may authenticate the product, and may use the unique customer identifier and the authentication information to derive the code that was originally sent to the buyer when they purchase the product. The resulting code must match. Otherwise, the buyer or customer knows that the product has been changed.

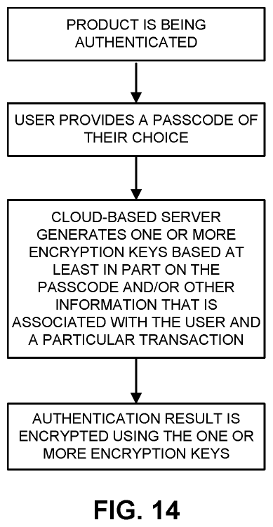

FIG. 14 presents a flow diagram illustrating an example of a method for authenticating a product or a service using a computer of FIG. 1. Note that, because the authentication of the product is independent of the passcode(s) provided by the user (the buyer of the object) and is also independent of the encryption key(s) provided by the authentication server, the result may be an end-to-end association preventing a man-in-the-middle changing the product.

For example, a product may be authenticated. Then, a user may provide a passcode of their choice. A cloud-based system may generate one or more encryption keys based on this passcode and/or other information (such as random information) that may be stored in the cloud-based system with is associated with this user and this commercial transaction. Notably, the authentication result may be encrypted using the one or more encryption keys. In some embodiments, a detailed three-dimensional (3D) image of the product (which may include high-resolution details) may be used as part of this authentication.

When the user subsequently receives the product, they may repeat the authentication process. If the same result is obtained, the authenticity of the product is confirmed. Otherwise, the user may know that the product they received is not the product that they purchased.

Note that is some embodiments, different types of codes, different hash functions or techniques, and/or different authentication techniques may be used in any of the preceding embodiments. Moreover, in the preceding embodiments, there may be additional or fewer operations, the order of the operations may be changed, there may be different operations and/or two or more operations may be combined into a single operation.

We now describe embodiments of an electronic device, which may perform at least some of the operations in the authentication techniques. FIG. 15 presents a block diagram illustrating an example of an electronic device 1500 in accordance with some embodiments, such as electronic device 110, electronic device 112, access point 114, base station 116, one of computers 120, etc. This electronic device includes processing subsystem 1510, memory subsystem 1512, and networking subsystem 1514. Processing subsystem 1510 includes one or more devices configured to perform computational operations. For example, processing subsystem 1510 can include one or more microprocessors, ASICs, microcontrollers, programmable-logic devices, one or more graphics process units (GPUs) and/or one or more digital signal processors (DSPs).

Memory subsystem 1512 includes one or more devices for storing data and/or instructions for processing subsystem 1510 and networking subsystem 1514. For example, memory subsystem 1512 can include dynamic random access memory (DRAM), static random access memory (SRAM), and/or other types of memory. In some embodiments, instructions for processing subsystem 1510 in memory subsystem 1512 include: one or more program modules or sets of instructions (such as program instructions 1522 or operating system 1524), which may be executed by processing subsystem 1510. Note that the one or more computer programs may constitute a computer-program mechanism. Moreover, instructions in the various modules in memory subsystem 1512 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 1510.

In addition, memory subsystem 1512 can include mechanisms for controlling access to the memory. In some embodiments, memory subsystem 1512 includes a memory hierarchy that comprises one or more caches coupled to a memory in electronic device 1500. In some of these embodiments, one or more of the caches is located in processing subsystem 1510.

In some embodiments, memory subsystem 1512 is coupled to one or more high-capacity mass-storage devices (not shown). For example, memory subsystem 1512 can be coupled to a magnetic or optical drive, a solid-state drive, or another type of mass-storage device. In these embodiments, memory subsystem 1512 can be used by electronic device 1500 as fast-access storage for often-used data, while the mass-storage device is used to store less frequently used data.

Networking subsystem 1514 includes one or more devices configured to couple to and communicate on a wired and/or wireless network (i.e., to perform network operations), including: control logic 1516, an interface circuit 1518 and one or more antennas 1520 (or antenna elements) and/or input/output (I/O) port 1530. (While FIG. 15 includes one or more antennas 1520, in some embodiments electronic device 1500 includes one or more nodes, such as nodes 1508, e.g., a network node that can be coupled or connected to a network or link, or an antenna node or a pad that can be coupled to the one or more antennas 1520. Thus, electronic device 1500 may or may not include the one or more antennas 1520.) For example, networking subsystem 1514 can include a Bluetooth™ networking system, a cellular networking system (e.g., a 3G/4G/5G network such as UMTS, LTE, etc.), a universal serial bus (USB) networking system, a networking system based on the standards described in IEEE 802.11 (e.g., a Wi-Fi® networking system), an Ethernet networking system, a cable modem networking system, and/or another networking system.

Networking subsystem 1514 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 1500 may use the mechanisms in networking subsystem 1514 for performing simple wireless communication between the electronic devices, e.g., transmitting advertising or beacon frames and/or scanning for advertising frames transmitted by other electronic devices as described previously.

Within electronic device 1500, processing subsystem 1510, memory subsystem 1512, and networking subsystem 1514 are coupled together using bus 1528. Bus 1528 may include an electrical, optical, and/or electro-optical connection that the subsystems can use to communicate commands and data among one another. Although only one bus 1528 is shown for clarity, different embodiments can include a different number or configuration of electrical, optical, and/or electro-optical connections among the subsystems.

In some embodiments, electronic device 1500 includes a display subsystem 1526 for displaying information on a display, which may include a display driver and the display, such as a liquid-crystal display, a multi-touch touchscreen, etc.

Electronic device 1500 can be (or can be included in) any electronic device with at least one network interface. For example, electronic device 1500 can be (or can be included in): a computer system (such as a cloud-based computer system or a distributed computer system), a desktop computer, a laptop computer, a subnotebook/netbook, a server, a tablet computer, a smartphone, a cellular telephone, a smartwatch, a consumer-electronic device, a portable computing device, an access point, a transceiver, a router, a switch, communication equipment, a computer network device, a stack of computer network devices, a controller, test equipment, a printer, and/or another electronic device.

Although specific components are used to describe electronic device 1500, in alternative embodiments, different components and/or subsystems may be present in electronic device 1500. For example, electronic device 1500 may include one or more additional processing subsystems, memory subsystems, networking subsystems, and/or display subsystems. Additionally, one or more of the subsystems may not be present in electronic device 1500. Moreover, in some embodiments, electronic device 1500 may include one or more additional subsystems that are not shown in FIG. 15, such as a user-interface subsystem 1532. Also, although separate subsystems are shown in FIG. 15, in some embodiments some or all of a given subsystem or component can be integrated into one or more of the other subsystems or component(s) in electronic device 1500. For example, in some embodiments program instructions 1522 are included in operating system 1524 and/or control logic 1516 is included in interface circuit 1518.

Moreover, the circuits and components in electronic device 1500 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’) may implement some or all of the functionality of networking subsystem 1514 (or, more generally, of electronic device 1500). The integrated circuit may include hardware and/or software mechanisms that are used for transmitting wireless signals from electronic device 1500 and receiving signals at electronic device 1500 from other electronic devices. Aside from the mechanisms herein described, radios are generally known in the art and hence are not described in detail. In general, networking subsystem 1514 and/or the integrated circuit can include any number of radios. Note that the radios in multiple-radio embodiments function in a similar way to the described single-radio embodiments.

In some embodiments, networking subsystem 1514 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals)

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used Ethernet, a cellular-telephone communication protocol and a Wi-Fi communication protocol as an illustrative example, in other embodiments a wide variety of communication protocols and, more generally, wired and/or wireless communication techniques may be used. Thus, the authentication technique may be used with a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the authentication technique may be implemented using program instructions 1522, operating system 1524 (such as a driver for interface circuit 1518) or in firmware in interface circuit 1518. Alternatively or additionally, at least some of the operations in the authentication technique may be implemented in a physical layer, such as hardware in interface circuit 1518.

In the preceding description, we refer to ‘some embodiments.’ Note that ‘some embodiments’ describes a subset of all of the possible embodiments, but does not always specify the same subset of embodiments. Moreover, note that numerical values in the preceding embodiments are illustrative examples of some embodiments. In other embodiments of the authentication technique, different numerical values may be used.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A computer, comprising:
an interface circuit configured to communicate with an electronic device;
memory storing program instructions; and
a processor, coupled to the interface circuit and the memory, configured to execute the program instructions, wherein, when executed by the processor, the program instructions cause the computer to perform operations comprising:
receiving, associated with the electronic device, a request to authenticate authenticity of a product, wherein the request comprises information specifying the product;
determining the authenticity of the product, wherein the determining comprises providing a set of questions addressed to the electronic device and receiving answers to the set of questions associated with the electronic device, and at least some of the questions in the set of questions are dynamically selected based at least in part on at least some of the answers; and
providing, addressed to the electronic device, information specifying the determined authenticity.

2. The computer of claim 1, wherein the product was manufactured before existence of an authentication service associated with the computer.

3. The computer of claim 1, wherein the authenticity is determined using a group of predefined authentication modules that are selected based at least in part on the product.

4. The computer of claim 3, wherein the group of predefined authentication modules comprise a pre-trained machine-learning model.

5. The computer of claim 3, wherein a sequence of the group of predefined authentication modules is selected based at least in part on the product.

6. The computer of claim 1, wherein the authenticity is determined based at least in part on a context of the authentication.

7. The computer of claim 6, wherein the context comprises a document in a network that is offering the product.

8. The computer of claim 7, wherein the document comprises a location of the document.

9. The computer of claim 7, wherein the document comprises a web page or a website.

10. The computer of claim 6, wherein the context comprises a number of authentication attempts for the product.

11. The computer of claim 6, wherein the context comprises a location in a network of the electronic device, which is purchasing the product.

12. The computer of claim 6, wherein the context comprises an authentication history of a purchaser of the product.

13. The computer of claim 1, wherein the set of questions comprise a request for information associated with a label of the product.

14. The computer of claim 13, wherein the information comprises an image of the label.

15. The computer of claim 14, wherein the determining comprises analyzing the label to identify random markings at different locations in the label.

16. The computer of claim 1, wherein the determining comprises requesting information from a counterparty to a party associated with the electronic device in a transaction associated with the product.

17. The computer of claim 1, wherein the computer provides instances of a common user interface to the party and the counterparty during the determining.

18. The computer of claim 1, wherein the determining comprises requesting information from a manufacturer of the product.

19. A non-transitory computer-readable storage medium for use in conjunction with a computer, the computer-readable storage medium storing program instructions that, when executed by the computer, causes the computer to perform operations comprising:
receiving, associated with an electronic device, a request to authenticate authenticity of a product, wherein the request comprises information specifying the product;
determining the authenticity of the product, wherein the determining comprises providing a set of questions addressed to the electronic device and receiving answers to the set of questions associated with the electronic device, and at least some of the questions in the set of questions are dynamically selected based at least in part on at least some of the answers; and
providing, addressed to the electronic device, information specifying the determined authenticity.

20. A method for determining authenticity of a product, comprising:
by a computer:
receiving, associated with the electronic device, a request to authenticate the authenticity of the product, wherein the request comprises information specifying the product;
determining the authenticity of the product, wherein the determining comprises providing a set of questions addressed to the electronic device and receiving answers to the set of questions associated with the electronic device, and at least some of the questions in the set of questions are dynamically selected based at least in part on at least some of the answers; and
providing, addressed to the electronic device, information specifying the determined authenticity.
